(19) United States
(12) Patent Application Publication
(10) Pub. No.: US 2007/0170788 A1
(43) Pub. Date: Jul. 26, 2007

(54) Method and device for altering the vibration characteristic of a motor system

(76) Inventor: Ulrich Werner, Bubenreuth (DE)

Correspondence Address: HENRY M FEIEREISEN, LLC, 350 FIFTH AVENUE, SUITE 4714, NEW YORK, NY, 10118, US

(21) Appl. No.: 10/595,244

(22) PCT Filed: Sep. 23, 2004
(86) PCT No.: PCT/EP04/10689

§ 371 Date: Mar. 7, 2007

(30) Foreign Application Priority Data
Sep. 29, 2003 (DE) 103 45 605.8

(51) Int. Cl. B62D 7/16; H02K 5/24

(52) U.S. Cl. 310/51; 403/42; 310/254

(57) ABSTRACT

The invention relates to a method for operation of a motor system (1), or a motor system (1), comprising an electrical motor (2) and an add-on module (3), whereby the add-on module (3) is mounted on the electrical motor (1), by means of a fixing system (11). A first fixing system (11) may be exchanged for a second fixing system (12) of a different type and is exchanged to alter the vibration characteristics of the motor system (1). A motor system (1) is furthermore provided with different fixing positions (13, 15, 17, 19) for the fitting of the add-on module (3) to the electrical motor (2) by means of fixing systems (11). The fixing positions (13, 15, 17, 19) are only partly occupied by a fixing system (11), whereby a change in vibration characteristics for the motor system (1) may be particularly achieved, by means of changing the occupation of the fixing positions (13, 15, 17, 19)

The invention relates to a machine system, with an electric machine and an add-on module installed on the machine. The add-on module installed on the electric machine is secured by way of a mounting system. A single mounting system or several mounting systems can be used. A mounting system is, for example, a screw connection including a screw, a nut and/or an interior thread. One example for an add-on module is a top-mounted cooler for an electric machine.

Electric machines and the corresponding foundation have common system resonance frequencies. Machine systems and/or electric machines are designed with respect to their vibration characteristics according to established standards and specifications, and mostly for a hard installation. Electric machine-foundation systems with system resonance frequencies corresponding to the excitation frequencies of the rotation frequency and/or, preferable for two-pole machines, of twice the mains frequency, can cause considerable vibration problems. Motors which do not show any vibration-related problems during acceptance tests performed on “hard” foundations, can still exhibit vibration problems at the customer sites on “soft” foundations. When a machine system is to be installed on a foundation, the system designer frequently does not design the foundation with the vibration characteristics of the machine system in mind. An elastic installation may therefore be used in many situations. However, an elastic installation changes the system resonance frequencies of the machine system or of the electric machine. This may cause vibration problems if one of the system resonance frequencies of the machine system or of the electric machine is in a range of an excitation frequency.

If vibration problems are observed during the operation of the machine system or if the vibration constraints according to industrial standards or customer requirements are not satisfied, then such vibration problems, which are in particular caused by operating the machine near a resonance, may be overcome by at least one of the following measures:
1) a change in the stiffness of the foundation, which can be problematic because
   a) this is frequently not possible after installation;
   b) changes in the foundation frequently change the stiffness not only in the desired direction, but also in other directions;
   c) the stiffness of the foundation is often difficult to measure.
2) balancing the machine during operation on the original foundation to minimize the excitation;
3) development/construction of new rotors; this may delay in bringing the machine into operational use.

Such measures are quite complex, expensive and/or time-consuming.

It is an object of the invention to provide a machine system and a method for operating a machine system which solve occurring vibration problems in a simple manner. The object is solved by a machine system with the features of claim 1 and by a machine system with the features of claim 2, and by a method of operating a machine system with the characteristic features of claim 10. The dependent claims 3 to 9 and 11 to 13 are inventive modifications of the machine system and of the method, respectively. The object is also solved by use of the method in a machine system.

A machine system has an electric machine and an add-on module. The add-on module is mounted on the electric machine with a mounting system. A first mounting system can hereby be exchanged for a second mounting system, wherein the first mounting system and the second mounting system are of a different type. The vibration characteristics of the machine system can be changed by exchanging the mounting systems of different types.

A mounting system is, for example, a screw connection, which includes at least one screw and a corresponding interior thread or a nut. The screw is constructed with predetermined elastic or resilient properties. Screws with different characteristics can be employed. For example, the mounting system can in addition include a washer, a spring ring and the like.

The object is solved by a machine system with an electric machine and an add-on module, wherein the add-on module is attached to the electric machine with a mounting system. The machine system has various mounting locations where the add-on module can be attached to the electric machine using the mounting systems. The various mounting locations are, for example, threaded bores in a housing of an electric machine adapted to receive screws. The add-on module can be attached to the machine with the screws by way of a bolt head or a nut and an interior thread which is integrated in the add-on module or in the electric machine. The mounting system only uses a portion of the mounting locations. The vibration characteristic of the machine can be altered by changing the configuration and/or the number of the mounting locations. The vibration characteristic of the machine system depends, in particular, on the add-on module of the electric machine and the foundation on which the machine system is mounted, as well as on the coupling between the add-on module and the electric machine.

The add-on module can be mounted or secured at selectable mounting locations by changing between different mounting locations or by selecting other, different suitable mounting locations. Because changing the number of mounting locations can have a different effect on the coupling stiffness of the add-on module and/or the electric machine, the vibration characteristics of the machine system can be affected. The directional components of a vibration should also be considered when assessing the vibration characteristic.

According to an advantageous embodiment, a first mounting system can be replaced with a second mounting system of a different type, whereby such replacement can cause changes in the vibration characteristics of the machine system. The number of different mounting systems, i.e., mounting systems of different types, can be combined with the selection of different mounting locations.

According to an advantageous embodiment, the mounting system includes a coupling element. In particular, the coupling element can be employed with a screw connection, whereby the coupling element is located in the screw connection between the electric machine and the add-on module. The coupling element is, for example, placed directly at a screw connection or remote from the screw connection. An exemplary coupling element can be, besides a washer, a spring ring and the like, but also a rubber lip or a sealing ring, which can also function as a seal.

According to an advantageous embodiment, the mounting system or the coupling element are implemented as a spring and/or as a damper. The spring and/or damping characteristics of the coupling element can be used to change or adjust the vibration characteristic of the machine system.

The material for the coupling element can be, for example, a rubber material or a plastic material.

According to an advantageous embodiment, the mounting system and/or the coupling system includes an absorber. An absorber is provided to absorb vibration energy, so that when a machine system that starts to vibrate, the vibrations can be damped by removing energy.

According to an advantageous embodiment, the add-on module on the electric machine is a top-mounted cooler of the electric machine. The top-mounted cooler is provided for cooling the machine. Such top-mounted coolers have sufficient mass to affect the vibration characteristic of the machine system. In addition, top-mounted coolers may already be installed on an electric machine by using mounting systems. Top-mounted coolers can be implemented, for example, as air-air coolers or also as air-water coolers.

According to another advantageous embodiment, the add-on module has already different mounting systems for installation on the electric machine, whereby the different mounting systems are of different types. The vibration characteristic of the machine system can then be altered by selecting a suitable mounting system. For example, if a screw connection includes a coupling element, for example a rubber element disposed between the add-on manual and electric machine, in particular the housing of the electric machine, then the vibration characteristic of the machine system can be altered by replacing the coupling element with a softer or a harder coupling element.

The vibration problems can be ameliorated by changing the system resonance frequency of the machine system. Problems occur, in particular, when the machine system is excited near its characteristic frequency. The characteristic frequency must then be changed. The system resonance frequency can be changed, in particular, by adjusting a resilient coupling between the add-on module and the electric machine. The resilient coupling is implemented by way of the mounting system. For example, the system resonance frequency of the machine system can be shifted in machine system with an electric machine with a top-mounted cooler by changing the stiffness of the coupling of the top-mounted cooler, so that vibration problems resulting from the proximity to the resonance can be prevented. In addition, if the stiffness of the foundation is known, the top-mounted cooler can be used as an absorber through suitable selection of the coupling stiffness of the cooler, so as to eliminate the vibration amplitudes of a rotor or a stator of the electric machine, or to eliminate the amplitude difference between the stator and rotor.

According to another advantageous embodiment of the motor system, the add-on module has at least 1/20 of the mass of the electric machine.

In a method for operating at machine system with an electric machine and an add-on module, wherein the add-on module is secured on the electric machine with a mounting system, at least a first mounting system can be replaced with a second mounting system of a different type, wherein the vibration characteristic of the machine system is changed by replacing the first mounting system with the second mounting system.

In another method for operating a machine system with an electric machine and an add-on module, wherein the add-on module is installed on the electric machine with a mounting system and the machine system has different mounting locations for mounting the add-on module on the electric machine with the mounting systems, the mounting system occupies only a portion of the mounting locations. Thereafter, different the mounting locations are used for the mounting system, which causes changes in the vibration characteristic of the machine system.

In a machine system having different mounting locations, not only the mounting locations themselves, but also mounting systems of different types can be selected. The vibration characteristic of the machine system can be altered by replacing a first mounting system with a second mounting system of a different type.

Advantageously, the number of the mounting locations for securing a mounting system can be combined with a selection of different mounting systems of a different type. The characteristic frequency of the machine system can thereby be changed over a particularly wide frequency range.

Exemplary embodiments of the invention will be described with reference to the appended drawings.

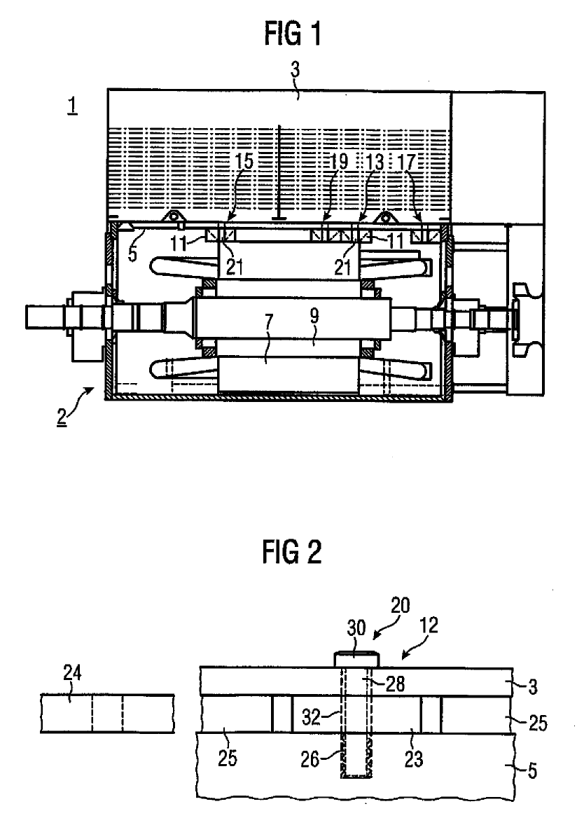

FIG. 1 shows a machine system 1,

FIG. 2 shows a mounting system,

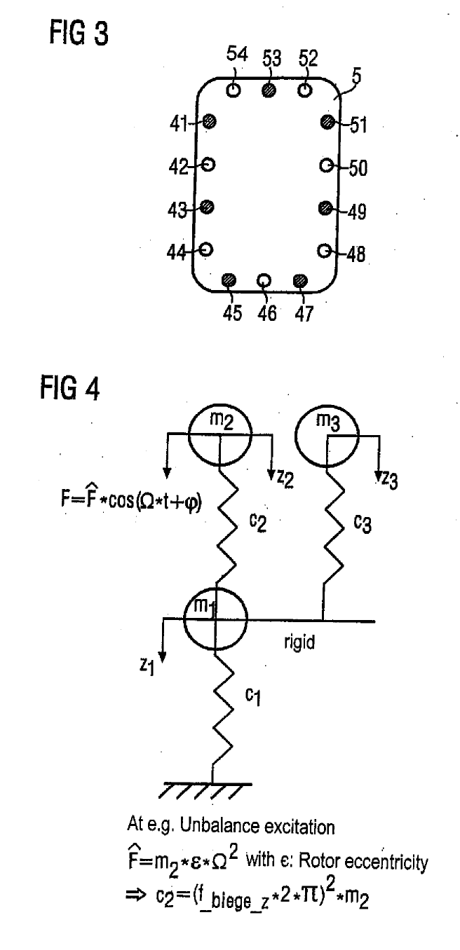

FIG. 3 shows different mounting locations,

FIG. 4 shows a vibration model with three masses,

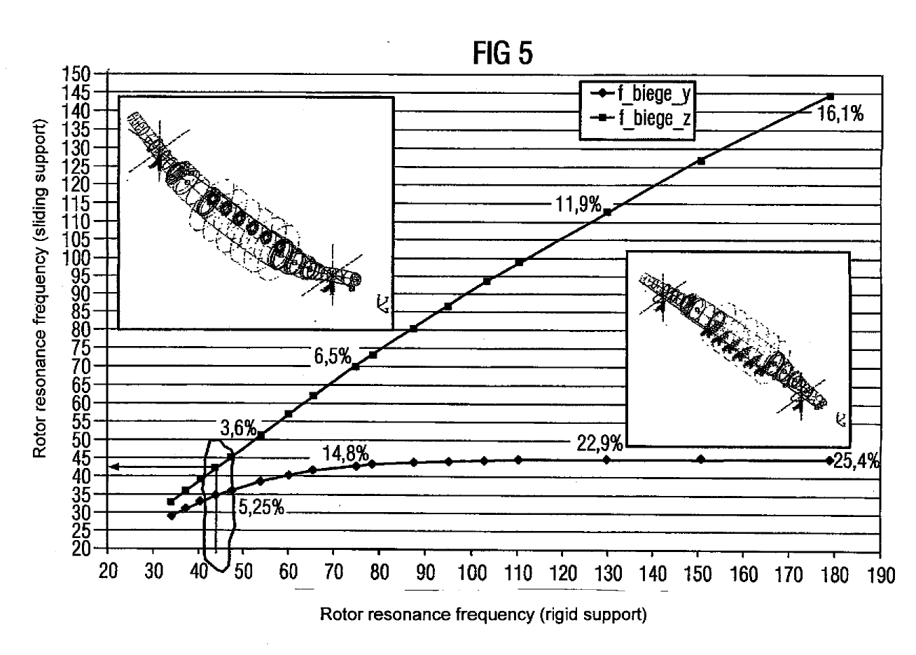

FIG. 5 shows bending resonance frequencies, and

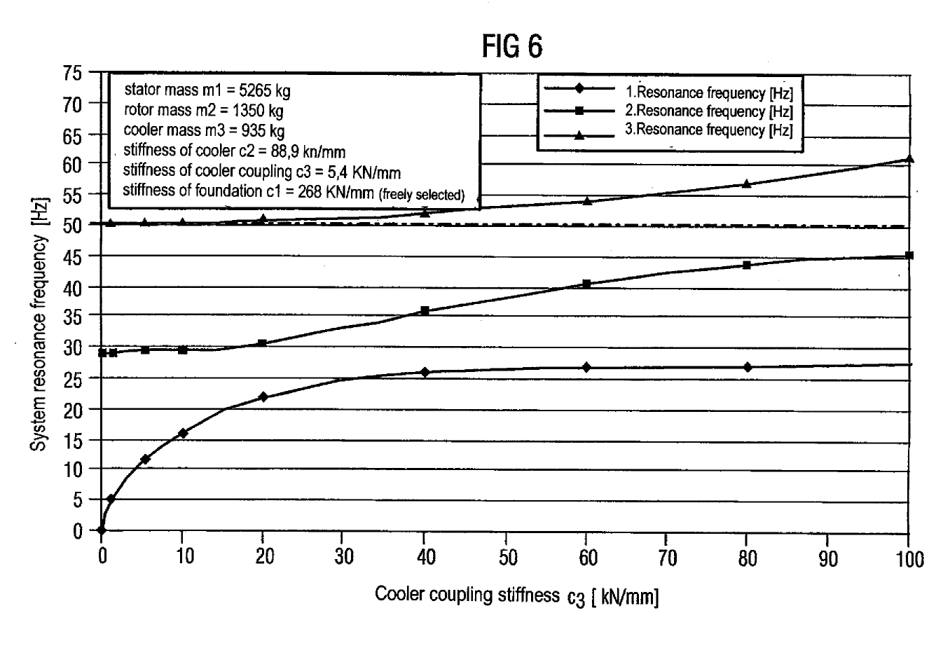

FIG. 6 shows system resonance frequencies as a function of a cooler coupling stiffness.

The illustration of FIG. 1 shows a machine system 1. The machine system 1 includes an electric machine 2 and an add-on module 3. The add-on module 3 is a top-mounted cooler. The electric machine also includes a rotor 9, a stator 7 and a housing 5. The add-on module 3 is mounted to the electric machine 2 with the mounting systems 11 and 12 at mounting locations 13, 15, 17 and 19 by using, for example, a screw connection 21.

The diagram of FIG. 2 shows a detail of the housing 5 of the electric machine, whereby the housing 5 has an interior thread 26, in which a screw 28 is inserted. The add-on module 3 and the housing 5 of the electric machine are connected by a bolt head 30. A coupling element 23 is installed between the add-on module 3 and the housing 5. This coupling element has a bore 32 through which the screw 28 passes. The coupling element 23 can be replaced, for example, by the coupling element 24, which is of a type different from the coupling element 23. The difference can be, for example, a difference in the thickness and/or the material. Alternatively or in combination, coupling elements 25 which are remote from the mounting location 20 can be used addition to the coupling element 23, 24 positioned directly at the mounting location 20.

The diagram of FIG. 3 illustrates the different mounting locations. On a housing 5 having different mounting locations, only half of these mounting locations may be necessary for mounting an add-on module. In the illustrated example, the mounting locations are illustrated by filled and unfilled circles. An add-on module can be installed on a housing, for example, at mounting locations 41, 43, 45, 47, 49, 51 and 53, whereby the add-on module can also be installed at the mounting locations 42, 44, 46, 48, 50, 52 and 53. Selection of the mounting locations can change the coupling between the add-on module and the electric machine, which then also changes the vibration characteristic of the machine system.

The diagram of FIG. 3 shows a vibration model, depicted as a three-mass vibration model, wherein the three masses m₁, m₂ and m₃ represent the major masses of the machine system. For example, m₁ represents the entire mass of the motor, minus the masses m₂ and m₃. m₂ represents the mass of the rotor and m₃ represents the mass of the top-mounted component, i.e., for example the mass of a top-mounted cooler of the electric machine. The three-mass system can be harmonically excited by a force F. The vibration model describes the translation in the vertical direction. The three masses stator, rotor and cooler are elastically connected with one another. The vibration system is excited to perform forced vibrations, for example, by excitation from an unbalance. The stiffness in the system is given by the parameters c₁, c₂ and c₃, wherein c₁ is the vertical stiffness, and c₂ is the vertical stiffness between rotor mass and stator mass, which is calculated from the first resonance bending shape in the z-direction. The parameter c₃ represents the vertical stiffness of the supporting rubber elements between the stator and the add-on module, in particular the top-mounted cooler. The symbol ε indicates the rotor eccentricity.

The vibration amplitudes for harmonic excitation of the rotor are;

$${z}_{1 p} = \frac{- {c}_{2} \hat{F} \cdot ( {m}_{3} \cdot {Ω}^{2} - {c}_{3} )}{α}$$

$${z}_{2 p} = \frac{\hat{F} \cdot [ ( - {m}_{1} \cdot {Ω}^{2} + {c}_{1} + {c}_{2} + {c}_{3} ) \cdot ( {m}_{3} {Ω}^{2} - {c}_{3} ) + {c}_{3}^{2} ]}{α}$$

$${z}_{3 p} = \frac{\hat{F} \cdot {c}_{2} \cdot {c}_{3}}{α}$$

The system resonance frequencies and hence the location of the resonance frequencies can be shifted by changing the stiffness of the coupling between the add-on module and electric machine, because α is a function of c₃. The stiffness can be changed, for example, by using coupling elements such as rubber elements of different type, i.e., with different stiffness.
a=(−m₁·Ω²+c₂+c₃)·(m₂·Ω²−c₂)·(m₃·Ω²·c₃)+c₂²·(m₃·Ω²−c₃)+c₃²·(m₂·Ω²−c₂)

In an advantageous embodiment, the mass of the add-on module, for example the top-mounted cooler, can be employed as an absorber. Accordingly, with a predefined stiffness of the foundation, the cooler mass is to be inserted as absorber. This can also be accomplished by a suitable selection of the cooler coupling stiffness c₃.

Elimination of the Vibration Amplitude z₁ₚ (Stator Amplitude):

The vibration amplitude z₁ₚ is eliminated (z₁ₚ=0) at the cooler coupling stiffness c₃:
c₃=m₃·Ω²

This cooler coupling stiffness c₃ produces the following amplitudes:

$${z}_{1 p} = 0 ; {z}_{2 p} = \frac{- \hat{F}}{( {m}_{2} \cdot {Ω}^{2} - {c}_{2} )} ; {z}_{3 p} = \frac{\hat{F} \cdot {c}_{2}}{( {m}_{2} \cdot {Ω}^{2} - {c}_{2} ) \cdot {c}_{3}}$$

It should be noted that the resonance moves closer to the zero crossing with increasing mounting frequency, because with increasing mounting frequency, the first system resonance frequency approaches the limit value:

$${lim {ω}_{1}}_{fa \to ∞} = \sqrt{\frac{{c}_{3}}{{m}_{3}}}$$

Elimination of the Vibration Amplitude z₂ₚ (Rotor Amplitude):

The vibration amplitude z₂ₚ is eliminated (z₂ₚ=0) at the cooler coupling stiffness c₃:

$${c}_{3} = \frac{{m}_{3} \cdot {Ω}^{2} \cdot [ {m}_{1} \cdot {Ω}^{2} - ( {c}_{1} + {c}_{2} ) ]}{( {m}_{1} + {m}_{3} ) \cdot {Ω}^{2} - ( {c}_{1} + {c}_{2} )} ≡ {\overline{c}}_{3}$$

This cooler coupling stiffness c₃ produces the following amplitudes:

$${z}_{1 p} = \frac{- {c}_{2} \cdot \hat{F} \cdot ( {m}_{3} \cdot {Ω}^{2} - {\overline{c}}_{3} )}{\begin{matrix}( - {m}_{1} \cdot {Ω}^{2} + {c}_{1} + {c}_{2} + {\overline{c}}_{3} ) \cdot ( {m}_{2} \cdot {Ω}^{2} - {c}_{2} ) \cdot ( {m}_{3} \cdot {Ω}^{2} - {\overline{c}}_{3} ) + \\ {c}_{2}^{2} \cdot ( {m}_{3} \cdot {Ω}^{2} - {\overline{c}}_{3} ) + {\overline{c}}_{3}^{2} \cdot ( {m}_{2} \cdot {Ω}^{2} - {c}_{2} )\end{matrix}}$$

$${z}_{2 p} = 0$$

$${z}_{3 p} = \frac{{c}_{2} \cdot {\overline{c}}_{3} \cdot \hat{F}}{\begin{matrix}( - {m}_{1} \cdot {Ω}^{2} + {c}_{1} + {c}_{2} + {\overline{c}}_{3} ) \cdot ( {m}_{2} \cdot {Ω}^{2} - {c}_{2} ) \cdot ( {m}_{3} \cdot {Ω}^{2} - {\overline{c}}_{3} ) + \\ {c}_{2}^{2} \cdot ( {m}_{3} \cdot {Ω}^{2} - {\overline{c}}_{3} ) + {\overline{c}}_{3}^{2} \cdot ( {m}_{2} \cdot {Ω}^{2} - {c}_{2} )\end{matrix}}$$

The vibration amplitude z₃ₚ cannot be eliminated.

Elimination of the Vibration Amplitude Difference Between the Stator and the Rotor: |z₁ₚ−z₂ₚ|

The vibration amplitude |z₁ₚ−z₂ₚ| is eliminated (|z₁ₚ−z₂ₚ|=0) at the cooler coupling stiffness c₃:

$${c}_{3} = \frac{{m}_{3} \cdot {Ω}^{2} \cdot [ {m}_{1} \cdot {Ω}^{2} - {c}_{1} ]}{( {m}_{1} + {m}_{3} ) \cdot {Ω}^{2} - {c}_{1}} ≡ {{c}^{=}}_{3}$$

This cooler coupling stiffness c₃ produces the following amplitudes:

$${z}_{1 p} = \frac{- {c}_{2} \cdot \hat{F} \cdot ( {m}_{3} \cdot {Ω}^{2} - {{c}^{=}}_{3} )}{\begin{matrix}( - {m}_{1} \cdot {Ω}^{2} + {c}_{1} + {c}_{2} + {{c}^{=}}_{3} ) \cdot ( {m}_{2} \cdot {Ω}^{2} - {c}_{2} ) \cdot ( {m}_{3} \cdot {Ω}^{2} - {{c}^{=}}_{3} ) + \\ {c}_{2}^{2} \cdot ( {m}_{3} \cdot {Ω}^{2} - {{c}^{=}}_{3} ) + {{c}^{=}}_{3}^{2} \cdot ( {m}_{2} \cdot {Ω}^{2} - {c}_{2} )\end{matrix}}$$

$${z}_{2 p} = {z}_{1 p}$$

$${z}_{3 p} = \frac{{c}_{2} \cdot {{c}^{=}}_{3} \cdot \hat{F}}{\begin{matrix}( - {m}_{1} \cdot {Ω}^{2} + {c}_{1} + {c}_{2} + {{c}^{=}}_{3} ) \cdot ( {m}_{2} \cdot {Ω}^{2} - {c}_{2} ) \cdot ( {m}_{3} \cdot {Ω}^{2} - {{c}^{=}}_{3} ) + \\ {c}_{2}^{2} \cdot ( {m}_{3} \cdot {Ω}^{2} - {{c}^{=}}_{3} ) + {{c}^{=}}_{3}^{2} \cdot ( {m}_{2} \cdot {Ω}^{2} - {c}_{2} )\end{matrix}}$$

The vibration amplitude z₃ₚ cannot be eliminated.

Elimination of the vibration amplitude difference between the stator and the rotor |z₁ₚ−z₂ₚ| can be computed, for example, as follows.

As a result, there is no longer a relative movement between the rotor mass and the stator mass.

The diagram of FIG. 5 shows the dependence of a first bending resonance frequency Y or z for a sliding bearing support with cylindrical bearing shell as a function of the rotor resonance frequency. The abscissa shows the rotor resonance frequency for a rigid support, whereas the ordinate shows the rotor resonance frequency for a sliding bearing support.

The diagram of FIG. 6 shows an exemplary resonance shift. A single mounting system or several mounting systems can be employed. For example, one type of mounting system is a screw connection which includes a screw and a nut or an interior thread, respectively. An example for an add-on module is a top-mounted cooler for an electric machine.

In the depicted example, with a predefined stiffness c₁ of the foundation, a resonance occurs for operation at 50 Hz, because that 3^{rd} system resonance frequency is also at approximately 50 Hz,

The system resonance frequencies can be shifted by altering the cooler coupling stiffness c₃. The system resonance frequencies increase with increasing stiffness c₃.

In the illustrated example, an adequate separation between the system resonance frequencies and the exciting rotor rotation frequency Ω can be maintained by increasing the cooler coupling stiffness from:
c₃=5.4 kN/mm [symbol] 80 kN/mm

However, it should be noted that the structural stiffness of the cooler becomes more important for the system resonance frequencies as the cooler coupling stiffness increases.

Accordingly, the machine can be adapted to a given foundation to optimize the vibration characteristic.

By a simple measure, namely through variation of the cooler coupling stiffness, the vibration properties can be optimized, resonances can be shifted, and amplitudes as well as amplitude differences can be minimized. This measure is significantly more cost-effective and less time-consuming than previously employed conventional methods.

With the invention, changes can advantageously be readily implemented on a system and/or at the installation site of the machine system, which enhances its utility for the customer.

1.-14. (canceled)

15. A machine system having a vibration characteristic, the system comprising:
an machine having a plurality of different mounting locations;
an add-on module; and
a mounting system for mounting the add-on module on the machine at selected ones of the plurality of different mounting locations, thereby producing a vibration characteristic, wherein the vibration characteristic of the machine system is changeable by mounting the add-on module at mounting locations different from the selected mounting locations.

16. The machine system of claim 15, wherein the mounting system includes at least a first mounting system and a second mounting system of a different type, wherein the vibration characteristics of the machine system is altered by replacing the first mounting system with the second mounting system.

17. The machine system of claim 15, wherein the mounting system includes a coupling element.

18. The machine system of claim 17 wherein the coupling element comprises a screw connection.

19. The machine system of claim 15, wherein the mounting system comprises at least one of a spring and a damper.

20. The machine system of claim 15, wherein the coupling element comprises at least one of a spring and a damper.

21. The machine system of claim 15, wherein the mounting system comprises a rubber material or a plastic material, or both.

22. The machine system of claim 15, wherein the coupling element comprises a rubber material or a plastic material, or both.

23. The machine system of claim 15, wherein the mounting system comprises an absorber.

24. The machine system of claim 15, wherein the coupling element comprises an absorber.

25. The machine system of claim 15, wherein the add-on module is a top-mounted cooler of the electric machine.

26. The machine system of claim 16, wherein the add-on component is attached to the machine by the first and second mounting systems.

27. The machine system of claim 15, wherein the machine is an electric machine.

28. A method of operating a machine system having an machine and an add-on module which is mounted on the machine by a mounting system, comprising the steps of:
mounting the add-on module on the machine with the mounting system at a first mounting location selected from a plurality of predetermined mounting locations;
mounting the machine system at another mounting location from the plurality of predetermined mounting locations, said other mounting location different from the first mounting location, to alter a vibration characteristic of the machine system.

29. The method of claim 28, wherein the mounting system includes at least a first mounting system and a second mounting system of a different type, wherein the vibration characteristics of the machine system is altered by replacing the first mounting system with the second mounting system.

30. The method of claim 28, wherein the mounting system includes at least one coupling element, and further comprising replacing the first coupling element with a second coupling element of a different type.

31. The method of claim 28, wherein the mounting system includes at least one coupling element, and further comprising adding to the first coupling element a second coupling element.

32. The method of claim 31, wherein the first coupling element and the second coupling element are of a different type.

33. The machine system of claim 28, wherein the machine is an electric machine.
